(19) United States
(12) Patent Application Publication
(10) Pub. No.: US 2015/0087411 A1
(43) Pub. Date: Mar. 26, 2015

(54) Wagering Game With Variable Award Associated With Play Counter

(71) Applicant: WMS Gaming Inc., Waukegan, IL (US)

(72) Inventors: Adam T. Gill, Waterloo (CA); Aaron Jon Schurman, Cedar Falls, IA (US); Nathan D. Sherrets, Cedar Rapids, IA (US); Bryan VanDaele, Cedar Falls, IA (US)

(73) Assignee: WMS Gaming Inc., Waukegan, IL (US)

(21) Appl. No.: 14/033,029

(22) Filed: Sep. 20, 2013

(51) Int. Cl. G07F 17/32

(52) U.S. Cl. CPC G07F 17/3258
USPC 463/27

(57) ABSTRACT

A computer-implemented method includes receiving an input indicative of a wager to play a wagering game. The method also includes displaying a play counter, a win condition, and an award for achieving the win condition in the wagering game. The play counter indicates a possible number of plays of the wagering game for which the award can be won by achieving the win condition. The method further includes, for each play of the wagering game, using a processor(s) to determine an outcome of the wagering game, advance the play counter in the absence of a reset condition, and provide the award if the win condition occurs in the wagering game. The method still further includes, in response to the reset condition, using a processor(s) to reset the play counter, modify the win condition, and modify the award for achieving the modified win condition in the wagering game.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to wagering games employing a variable award associated with a play counter.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

### SUMMARY OF THE INVENTION

According to one aspect of the present invention, a computer-implemented method includes receiving, via an input device, an input indicative of a wager to play a wagering game. The method also includes displaying, on a display device, a play counter, a win condition, and an award for achieving the win condition in the wagering game. The play counter indicates a possible number of plays of the wagering game for which the award can be won by achieving the win condition. The method further includes, for each play of the wagering game, using at least one of one or more processors to determine an outcome of the wagering game, advance the play counter in the absence of a reset condition, and provide the award if the win condition occurs in the wagering game. The method still further includes, in response to the reset condition, using at least one of the one or more processors to reset the play counter, modify the win condition, and modify the award for achieving the modified win condition in the wagering game.

According to another aspect of the invention, computer readable storage media is encoded with instructions for directing a gaming system to perform the above method.

According to yet another aspect of the invention, a gaming system includes one or more input devices, one or more display devices, and one or more processors. The gaming system also includes one or more memory devices storing instructions that, when executed by the one or more processors, cause the gaming system to receive, via at least one of the one or more input devices, an input indicative of a wager. The instructions, when executed by the one or more processors, also cause the gaming system to display, on at least one of the one or more display devices, a play counter, a win condition, and an award for achieving the win condition in the wagering game. The play counter indicates a possible number of plays of the wagering game for which the award can be won by achieving the win condition. The instructions, when executed by the one or more processors, also cause the gaming system to, for each play of the wagering game, determine an outcome of the wagering game, advance the play counter in the absence of a reset condition, and provide the award if the win condition occurs in the wagering game. The instructions, when executed by the one or more processors, further cause the gaming system to, in response to the reset condition, reset the play counter, modify the win condition, and modify the award for achieving the modified win condition in the wagering game.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming terminal according to an embodiment of the present invention.

FIG. 2 is a schematic view of a gaming system according to an embodiment of the present invention.

FIG. 3 is an image of an exemplary basic-game screen of a wagering game displayed on a gaming terminal, according to an embodiment of the present invention.

FIG. 4 is an image of an exemplary game screen of a wagering game displayed on a gaming terminal, according to an embodiment of the present invention.

FIG. 5 is an image of an exemplary game screen of a wagering game displayed on a gaming terminal, according to an embodiment of the present invention.

FIG. 6 is an image of an exemplary game screen of a wagering game displayed on a gaming terminal, according to an embodiment of the present invention.

FIG. 7 is an image of an exemplary game screen of a wagering game displayed on a gaming terminal, according to an embodiment of the present invention.

FIG. 8 is an image of an exemplary game screen of a wagering game displayed on a gaming terminal, according to an embodiment of the present invention.

FIG. 9 is an image of an exemplary game screen of a wagering game displayed on a gaming terminal, according to an embodiment of the present invention.

FIG. 10 is an image of an exemplary game screen of a wagering game displayed on a gaming terminal, according to an embodiment of the present invention.

FIGS. 11A-11G are images of exemplary game screens of a wagering game displayed on a gaming terminal, according to an embodiment of the present invention.

FIG. 12 is an image of an exemplary game screen of a wagering game displayed on a gaming terminal, according to an embodiment of the present invention.

FIG. 13 is an image of an exemplary game screen of a wagering game displayed on a gaming terminal, according to an embodiment of the present invention.

FIG. 14 is an exemplary flowchart for a method of conducting a wagering game, according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

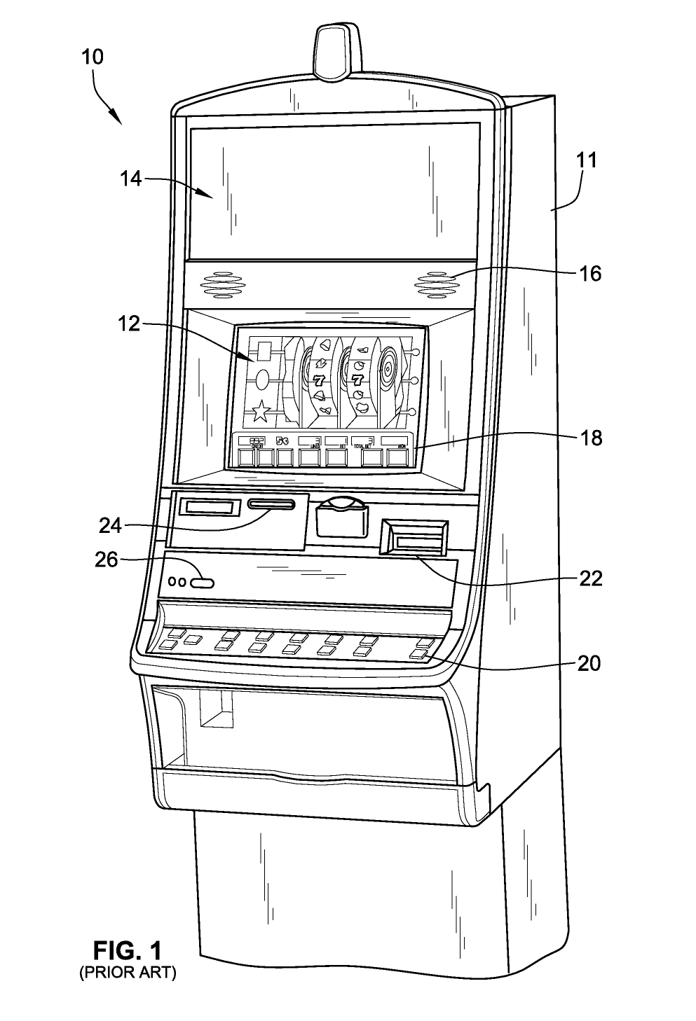

Referring to FIG. 1, there is shown a gaming terminal 10 similar to those used in gaming establishments, such as casinos. With regard to the present invention, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433, titled “Reel Spinning Slot Machine With Superimposed Video Image,” U.S. Patent Application Publication Nos. US2010/0069160, titled “Handheld Wagering Game Machine And Docking Unit,” and US2010/0234099, titled “Wagering Game System With Docking Stations” which are incorporated herein by reference in their entireties.

The gaming terminal 10 illustrated in FIG. 1 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

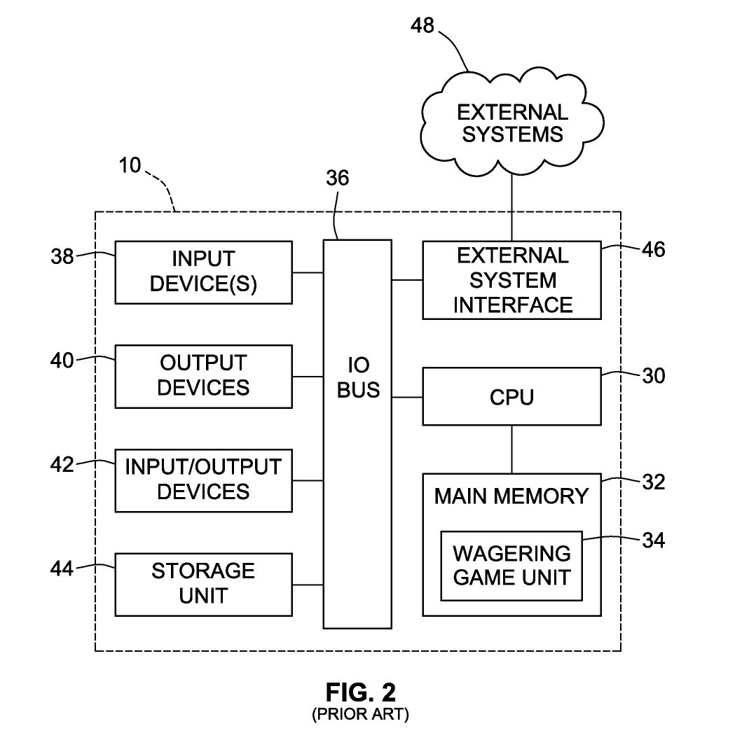

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving an input indicative of a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

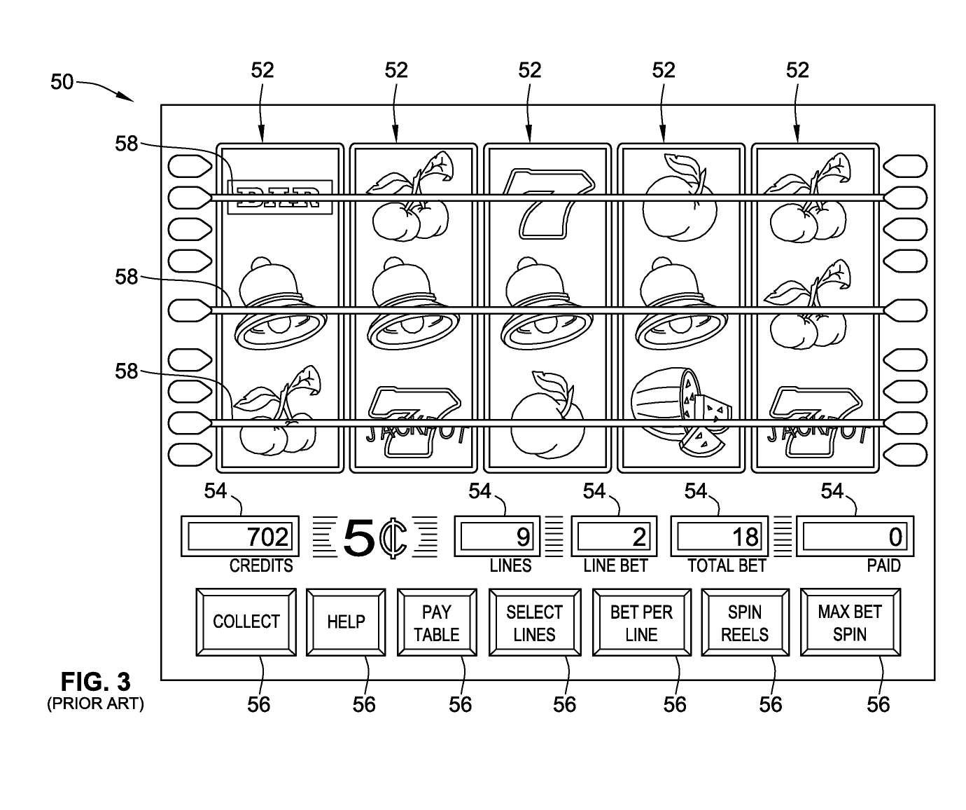

Referring now to FIGS. 4-14, embodiments of a wagering game employing a variable award associated with a play counter (i.e., a “variable award feature”) will be described. The variable award feature enhances the gaming experience by providing the player with changing opportunities to win different awards by achieving different win conditions within a limited number of plays of the wagering game. Knowing that he or she only has a limited number of attempts to achieve a potentially valuable award, the player experiences a heightened sense of suspense and excitement as a result of variable award feature.

FIGS. 4-13 illustrate images of exemplary game screens 150A-150P adapted to be displayed on the primary display area 12 or the secondary display area 14. The game screens 150A-150P include one or more game-session credit meters 154 and various touch buttons 156 adapted to be actuated by the player. The game screens 150 also portray a plurality of symbol-bearing reels 152 having a plurality of symbols and a plurality of payline indicators 162 for indicating one or more paylines (e.g., the payline 58 shown in FIG. 3).

According to aspects of the present disclosure, the game screens 150A-150P also include a plurality of indicators for implementing the variable award feature. In particular, the game screens 150A-150P include a variable award indicator 164, a win condition indicator 166, and a play count indictor 168. The variable award indicator 164 displays one of a plurality of different variable awards, the win condition indicator 166 displays one of a plurality of different variable win conditions, and the play count indicator 168 displays a play counter indicating a possible number of future plays of the wagering game for which the player can receive the award displayed in the variable award indicator 164 by achieving the variable win condition displayed in the win condition indicator 166.

Accordingly, in a wagering game employing the variable award feature, the award displayed in the variable award indicator 164 is awarded to the player in response to an outcome of the wagering game including the variable win condition displayed in the win condition indicator 166 before the play count indicator 168 indicates no plays remain (i.e., before the play count runs out). If the variable win condition is not achieved and, thus, the associated variable award not obtained by the player prior to the play count running out, the variable award feature is reset. That is, the play count is reset, a different one of the plurality of variable awards is displayed in the variable award indicator 164, and a different one of the plurality of variable win conditions is displayed in the win condition indicator 166. The player then has an opportunity to win the newly displayed variable award by achieving the newly displayed variable win condition before the new play count runs out. Each time the play count runs out, the award displayed in the variable award indicator 164 and the variable win condition displayed in the win condition indicator 166 are changed (i.e., the variable award feature is reset). In this way, the player is provided with changing opportunities to receive different variable awards based on different potential variable win conditions.

According to some aspects of the present disclosure, the variable award and variable win condition displayed in the indicators 164, 166 can also be changed in response to the displayed variable win condition being achieved prior to the play count running out. According to such aspects, the variable award feature can thus be reset in response to the earlier occurrence of the play count running out or the displayed variable win condition being achieved. However, according to alternative aspects, the variable feature can be reset only in response to the play count running out. Stated more generally, the variable award feature can be reset (i.e., a different variable award displayed, a different variable win condition displayed, and the play count reset) in response to an occurrence of a reset condition, where the reset condition includes the occurrence of the play count running out or, alternatively, the earlier occurrence of the play count running out or the displayed variable win condition being achieved.

According to some aspects of the present disclosure, the play count has an initial play-count value when the variable award feature is reset. Then, for each play of the wagering game that is conducted, the displayed play count is advanced until a reset condition occurs. The play count runs out when the play count is advanced to a threshold play-count value. The initial play-count value and the threshold play-count value can be numerical values. Accordingly, the play count can be advanced by decrementing or, alternatively, incrementing the play count by one for each play of the wagering game until the play count reaches the threshold numerical value. For implementations in which the play count is decremented by one for each play of the wagering game, the initial numerical value can be a number greater than zero (e.g., three, five, ten, etc.) and the threshold numerical value can be zero. In such implementations, the play count indicator 168 thus provides a countdown of the remaining plays until the variable award and the variable win condition displayed in the indicators 164, 166 are changed if the displayed variable win condition is not achieved. For implementations in which the play count is incremented by one for each play of the wagering game, the initial numerical value can be zero and the threshold numerical value can be a number greater than zero (e.g., three, five, ten, etc.). It should be understood that the particular numbers described above for the initial numerical value and the threshold numerical value are non-limiting examples and other numbers can be used.

While the play count displayed in the play count indicator 168 has been described in terms of a displayed number, it should be understood that, according to additional and/or alternative aspects, the play count can be indicated to the player in a graphical manner. For example, the initial play-count value and the threshold play-count value can be represented as respective quantities of displayed graphics (e.g., the initial play-count value can be displayed as a basket full of apples and the threshold play-count value can be displayed as an empty basket such that an apple is removed from the basket for each play of the wagering game to advance the play count). Additionally, for example, the play count can be represented by relational positions on a graphic (e.g., the play count indicator 168 can be an automobile gas meter where an initial play-count value is indicated by a gas meter needle at a full position, a threshold play-count value is indicated by the needle at an empty position, and the needle advances from the full position to the empty position for each play of the wagering game).

In the examples illustrated in FIGS. 4-13, the variable award indicator 164, the win condition indicator 166, and the play count indicator 168 are displayed in a banner 170 located above the reels 152A-152E. It should be understood that, according to additional and/or alternative aspects, the banner 170 can be displayed in other locations within the game screens 150A-150P (e.g., below the reels 152, on the side of the reels 152, etc.). It should also be understood that, according to additional and/or alternative aspects, the variable award indicator 164, the win condition indicator 166, and/or the player count indicator 168 can be displayed without a banner 170. However, displaying the indicators 164,166, 168 in the banner 170 can assist in implementing the variable award feature by facilitating the player's ability to easily understand the association between the award displayed in the variable award indicator 164, the variable win condition displayed in the win condition indicator 166, and the play count displayed in the play count indicator 168.

According to some aspects of the present disclosure, the occurrence of a reset condition can be indicated to the player in a way that allows the player to understand that the prior variable award opportunity has ended and a new variable award opportunity has now begun. For example, an audio and/or visual cue can be provided to the player to indicate a transition from one iteration of the variable award feature to another, different iteration of the variable award feature. In one non-limiting implementation, the entire banner 170 can appear to rotate or flip such that the prior displayed variable award is replaced with a different one of the plurality of variable awards, the displayed variable win condition is replaced with a different one of the plurality of variable win conditions, and the displayed play count is reset to an initial pay-count value. In another non-limiting implementation, a covering 172 can extend over the banner 170 and/or the indicators 164, 166, 168 for a brief period of time such that, when the covering is removed, the indicators 164, 166, 168 display a different variable award, a different variable win condition, and a reset play count, as will be described below for FIG. 9. It should be understood that these implementations are provided as a few non-limiting examples of visual cues that may be provided to the player to indicate that the variable award feature is being reset. Any other graphics, animations, lights, sounds, etc. can be additionally and/or alternatively be provided to indicate that the variable award feature is being reset.

According to aspects of the present disclosure, the award displayed in the variable award indicator 164 can be a monetary amount, a credit amount, a bonus game, a modification to one or more symbols, a game enhancement for future plays, combinations thereof, and/or the like. As non-limiting examples, a game enhancement can include one or more multipliers, wilds, automatic nudges, pay table upgrades, scatter conversions, individual reel re-spins, free spins, morphs, automatic wager increases, hold symbols, symbol movements, combinations thereof, and/or the like.

A multiplier game enhancement can be provided to multiply a payout or other outcome awarded to the player. The value of the multiplier (e.g., 2× multiplier or 3× multiplier) can be a randomly determined or a fixed value. The value of the multiplier can be predetermined (i.e., determined prior to a play of the wagering game) or dynamically determined (i.e., during and/or after a play of the wagering game).

An automatic nudge game enhancement is advantageous in situations where a better payout can be achieved by moving symbols on one (or multiple) reels either up or down across a payline.

A different pay table game enhancement implements a different and higher-paying pay table, awarding larger payouts for various symbol combinations. For example if a combination of three “cherry” symbols normally pays out 200% of the original wager, the different pay table game enhancement may result in a payout of 300% of the original wager for the same combination.

An upgrade game enhancement causes a winning symbol combination to move up at least one winning symbol combination on the pay table for the gaming terminal 10. For example, a lower-paying combination of three “cherry” symbols may pay out as if the player had achieved three “3-bars” symbols, a better combination.

An extra-wild game enhancement causes a symbol that is normally a regular symbol, such as a “cherry” symbol or a “1-bar” symbol, to become a wild symbol.

The scatter game enhancement converts a line pay payout into a scatter payout, such that a winning combination of symbols need not be located all on a single active payline.

The right-to-left enhancement allows “right-to-left” combinations (i.e., combinations starting on the right-most reel and extending left across the reels) to win, in addition to the standard winning “left-to-right” combinations.

The re-spin enhancement re-spins one or more of the reels if the player does not achieve any winning combination and/or a winning combination associated with an award above a predetermined amount, giving the player an additional chance to get a winning combination and/or a better winning combination.

The morph game enhancement allows one or more symbols on the reels to morph into other symbols that are more beneficial.

The hold symbol game enhancement holds one or more symbols in a certain location on the reels so that, after respinning, a final symbol combination across the reels takes into account the held symbol.

The symbol movement game enhancement allows one or more symbols to move to other locations along a payline if it would result in a better outcome (e.g., a higher award).

A winning combination typically results in a payout that is generally proportionate to the amount wagered. For example, when five credits are wagered and the player achieves a winning combination, the payout is at least five times as large as it would have been if only one credit had been wagered. The increased wager game enhancement treats a winning combination as though the player had bet the maximum amount, thereby effectively increasing the wagered amount, resulting in a higher payout. For example, of the player had only wagered one of five possible credits, the increased wager game enhancement would treat the player's wager as though five credits had been wagered.

It should be understood that the game enhancements described above are provided as examples of potential game enhancements. It is contemplated that other game enhancements can be employed in connection with the variable award functionalities described herein.

According to aspects of the present disclosure, the plurality of variable win conditions that can be displayed in the win condition indicator 166 can include one or more line pay outcomes, one or more scatter pay outcomes, and/or one or more bonus game triggering outcomes. As one non-limiting example, the plurality of potential variable win conditions can include one or more particular three symbol line pay outcomes, one or more particular four symbol line pay outcomes, one or more particular five symbol line pay outcomes, one or more particular three symbol scatter pay outcomes, one or more particular four symbol scatter pay outcomes, one or more particular five symbol scatter pay outcomes, one or more bonus game triggering outcomes, and/or other predefined patterns or arrangements of one or more particular symbols.

According to some aspects, each of the plurality of potential variable awards can be fixedly associated with a respective one of the plurality of variable win conditions. That is, the plurality of variable awards and the plurality of associated winning conditions can be paired in a fixed and predetermined manner. It is contemplated that, according to some aspects, the variable award feature can be configured such that the awards of greater value are fixedly associated with the variable win conditions that have a lower probability of occurrence and vice versa.

According to some implementations, the next variable award and variable win condition pair displayed in the indicators 164, 166 in response to a reset condition can be based on a predetermined order. For example, if a variable award feature includes three pairs of variable awards and variable win conditions, successive iterations of the variable award feature can include a first pair followed by a second pair followed by a third pair followed by the first pair and so on.

According to other implementations, the next variable award and associated variable win condition pair displayed in the indicators 164, 166 can be randomly determined in response to a reset condition. In some examples, the plurality of awards and associated variable win conditions can each be equally probable of being displayed for the next iteration of the variable award feature. In other examples, the random determination of the next award and associated variable win condition to be displayed for the next iteration of the variable award feature can be based on weighted probabilities. The weighting can be configured such that the variable awards having greater value occur less frequently. The weighting can additionally and/or alternatively be based on a turnover amount (i.e., an amount wagered over a plurality of plays or, alternatively, a period of time).

According to alternative aspects, the variable award displayed in the variable award indicator 164 and the variable win condition displayed in win condition indicator 166 can be dynamically determined in response to a reset condition. That is, the association between the plurality of potential variable awards and the plurality of potential wining outcomes can vary. For example, if the plurality of variable awards included a first award and a second award and the plurality of variable win conditions included a first variable win condition and a second variable win condition, the first variable award may be associated with the first variable win condition for a first iteration of the variable award feature, the first variable award may be associated with the second variable win condition for a second iteration, the second variable award may be associated with the first variable win condition for a third iteration, and the second variable award may be associated with the second variable win condition for a fourth iteration. The dynamic determination of the next variable award and variable win condition for the variable award feature can be based on equal probabilities or weighted probabilities.

According to aspects of the present disclosure, the variable award feature can be provided as part of a basic game and/or a bonus game. The wagering game can include a pay table indicating standard line pays and/or scatter pays that are not associated with a play count, which can be awarded to the player based on the outcomes of the wagering game achieved by the player during the plays of the wagering game. These standard line pays and/or scatter pays differ from the variable award and the variable win condition in that they are independent of a play count and, thus, not changed in response to a play count running out. The variable award feature thus provides players with additional opportunities to receive different payouts in addition to the standard pay table payouts of the wagering game.

A series of plays of an exemplary wagering game employing a variable award feature will now be described with reference to FIGS. 4-13. It should be understood that the wagering game illustrated and described for FIGS. 4-13 is intended as one non-limiting example of a wagering game employing a variable award associated with a play count. Other examples consistent with the variable award features described herein are contemplated.

In the example illustrated in FIGS. 4-13, the variable award indicator 164, the win condition indicator 166, and the play count indicator 168 are displayed in the banner 170 above the reels 152. The banner 170 also includes a textual indicator “within” to provide additional contextual cues to the player as to the nature of the variable award feature (e.g., that the displayed variable win condition must be achieved before the play count runs out to receive the displayed award). Also, in the illustrated example, the variable award meter 164 is configured to indicate a number of credits and the win condition indicator 166 is configured to indicate a line pay outcome for the active iteration of the variable award feature. As shown in FIGS. 4-13, the win condition indicator 166 displays a graphic representation of the symbols that comprise the variable win condition for the active iteration of the variable award feature.

Additionally, in the illustrated example, the play count is configured to be reset at an initial play-count value of ten plays of the wagering game and run out when advanced to a threshold play-count value of zero plays. Further, the variable award feature is configured to reset in response to an outcome of the wagering game including the variable win condition displayed in the win condition indicator 166 (i.e., the symbols displayed on an active payline including the combination of symbols displayed in the variable win condition indicator 166). Thus, the exemplary threshold based feature of FIGS. 4-13 has a reset condition that includes the earlier of the play count reaching the threshold play-count value or the displayed variable win condition being achieved.

FIG. 4 illustrates a game screen 150A including an outcome of the wagering game after the first six plays have already occurred for a first iteration of the variable award feature (i.e., the outcome for the sixth play of the first iteration of the variable award feature). Accordingly, the play count indicator 168 indicates that at most four plays remain until the reset condition occurs. As shown in FIG. 4, the variable award indicator 164 indicates that the variable award is 4,625 credits and the win condition indicator 166 indicates that the variable win condition is a line pay outcome including four “space capsule” symbols for the first iteration of the variable award feature.

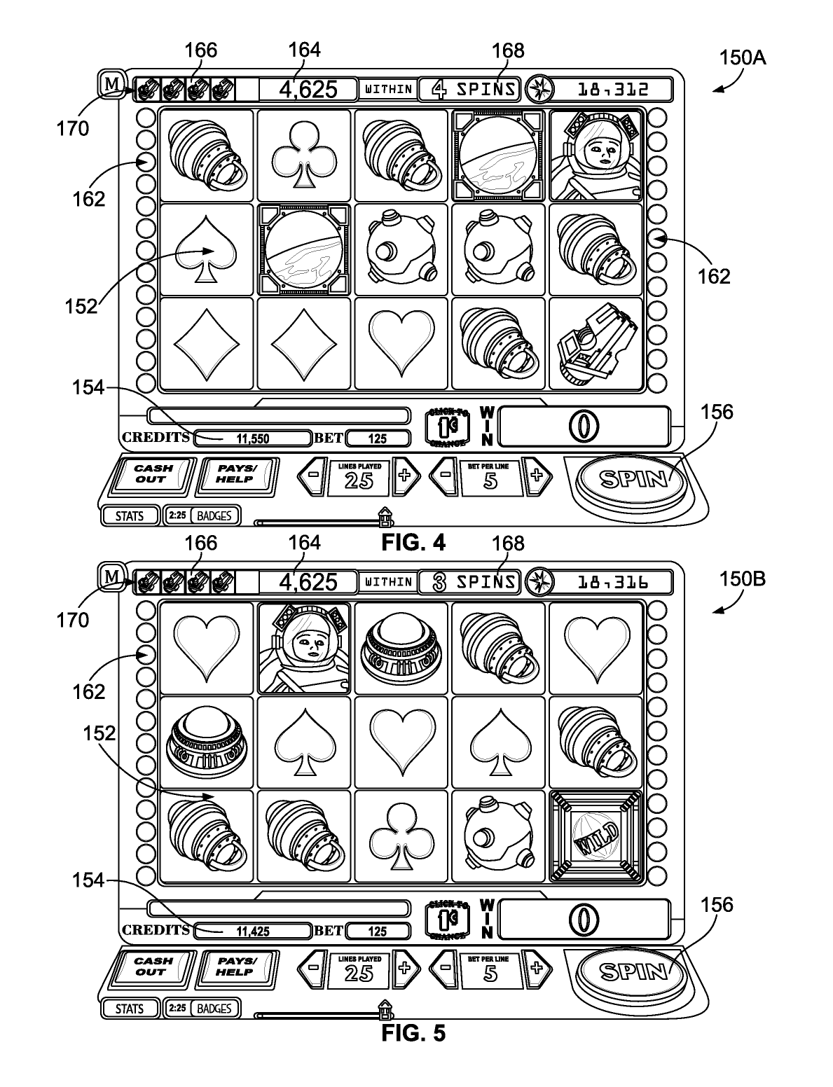

The wagering game progresses in response to the player initiating the next play of the wagering game. After selecting a number of paylines to play (e.g., 25 paylines), a number of credits to wager on each payline (e.g., 5 credits per payline), the player spins the reels 152 (e.g., via the “SPIN” button 156). The resulting outcome of the wagering game for this play (i.e., the seventh play of the first iteration of the variable award feature) is illustrated in FIG. 5. As the outcome illustrated in FIG. 5 does not include the variable win condition displayed in the win condition indicator 168, the variable award is not awarded to the player. Additionally, because the outcome illustrated in FIG. 5 does not include any line pay outcomes or scatter outcomes provided in a pay table, no standard payouts are awarded to the player.

In addition to setting the reels 152 in motion, detection of player input via the “SPIN” button 156 causes the play count indicator 168 to advance. As shown in FIG. 5, the play count indicator 168 has been decremented by one to indicate that at most three plays of the wagering game remain until the reset condition occurs. The detection of the “SPIN” button actuation can also cause the credit meter 154 to decrement by the wagered bet amount. As shown in FIGS. 4-5, the credit meter 154 has been decremented from 11,550 credits (as shown in FIG. 4) to 11,425 credits (as shown in FIG. 5) to reflect the 125 credits wagered.

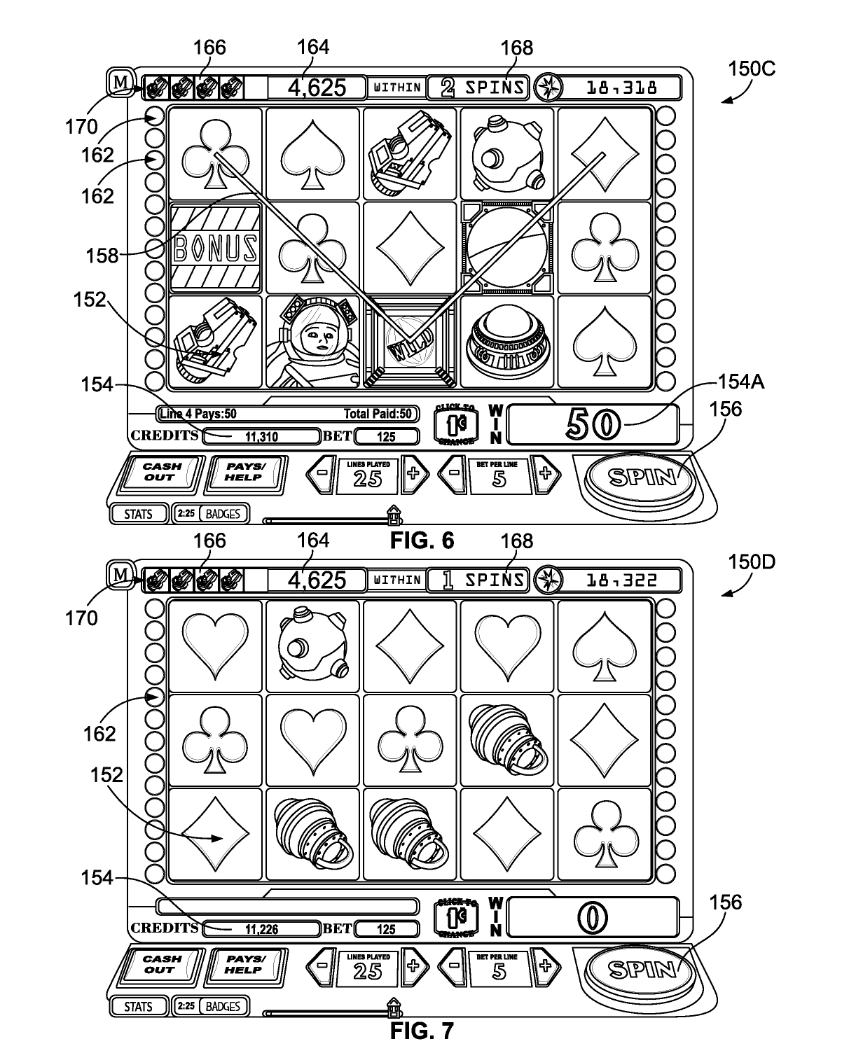

FIG. 6 illustrates a game screen 150C including an outcome for the next play of the wagering game (i.e., the eighth play of the first iteration of the variable amount feature). As shown in FIG. 6, the outcome of the wagering game does not include the variable win condition displayed in the win condition indicator 168 and, thus, the variable award displayed in the variable award indicator 164 is not awarded to the player. However, the outcome for the play shown in FIG. 6 includes one line pay outcome provided in the pay table as indicated by the active payline 158. In this illustrated example, the line pay outcome provided in the pay table awards the player 50 credits as indicated in the win meter 154A. The credit meter 154 thus indicates 11,350 credits after being incremented by 50 credits for the pay table based payout and decremented by the wager amount of 125 credits in FIG. 6. As shown in FIG. 6, the play count indicator 168 has been decremented by one to reflect that at most two plays remain for the first iteration of the variable award feature until a reset condition occurs.

FIG. 7 illustrates a game screen 150D including an outcome for the ninth play of the wagering game during the first iteration of the variable award feature. As shown in FIG. 7, the outcome does not include the variable win condition displayed in the win condition indicator 168 or a pay table based outcome and, thus, neither the variable award displayed in the variable award indicator 164 nor a pay table based award are provided to the player. As shown in FIG. 7, the play count indicator 168 has been decremented by one to reflect that at most one play remains, and the credit meter 154 has been decremented by the wager amount.

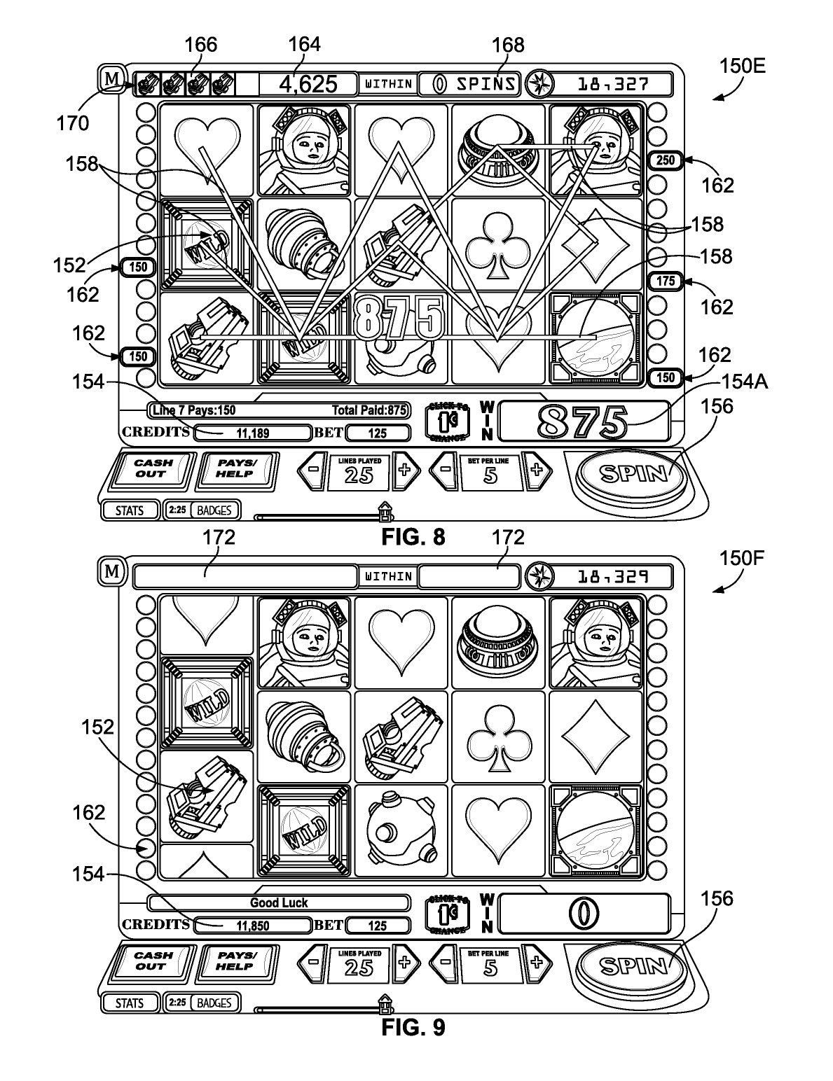

FIG. 8 illustrates a game screen 150E including an outcome for the tenth play of the wagering game during the first iteration of the variable award feature. As shown in FIG. 8, the outcome does not include the variable win condition displayed in the win condition indicator 168 and, thus, the variable award displayed in the variable award indicator 164 is not awarded to the player. However, the outcome for the play of FIG. 8 includes five line pay outcomes provided in the pay table as indicated by the active paylines 158 and the payline indicators 162. In this illustrated example, the line pay outcomes provided in the pay table award the player 875 credits as indicated in the win meter 154A. The credit meter 154 thus indicates 11,975 credits after being incremented by 875 credits for the pay table based payout and decremented by the wager amount of 125 credits in FIG. 8.

As shown in FIG. 8, the play count indicator 168 has been decremented by one to reflect that zero plays remain for the first iteration of the variable award feature until a reset condition occurs. In other words, the play count has been advanced to the threshold value of zero and, thus, one of the reset conditions has occurred. In response to the occurrence of the win condition, the variable award feature is reset. FIG. 9 illustrates a game screen 150F including a graphic for indicating the transition of the variable award feature from the first iteration to a second iteration. In particular, the transition graphic is a covering 172 that has extended over the banner 170 in the game screen of FIG. 9. To complete the reset of the variable award feature, the covering 172 is removed to display a different one of the plurality of variable awards, a different one of the variable win conditions, and the play count rest to its initial value.

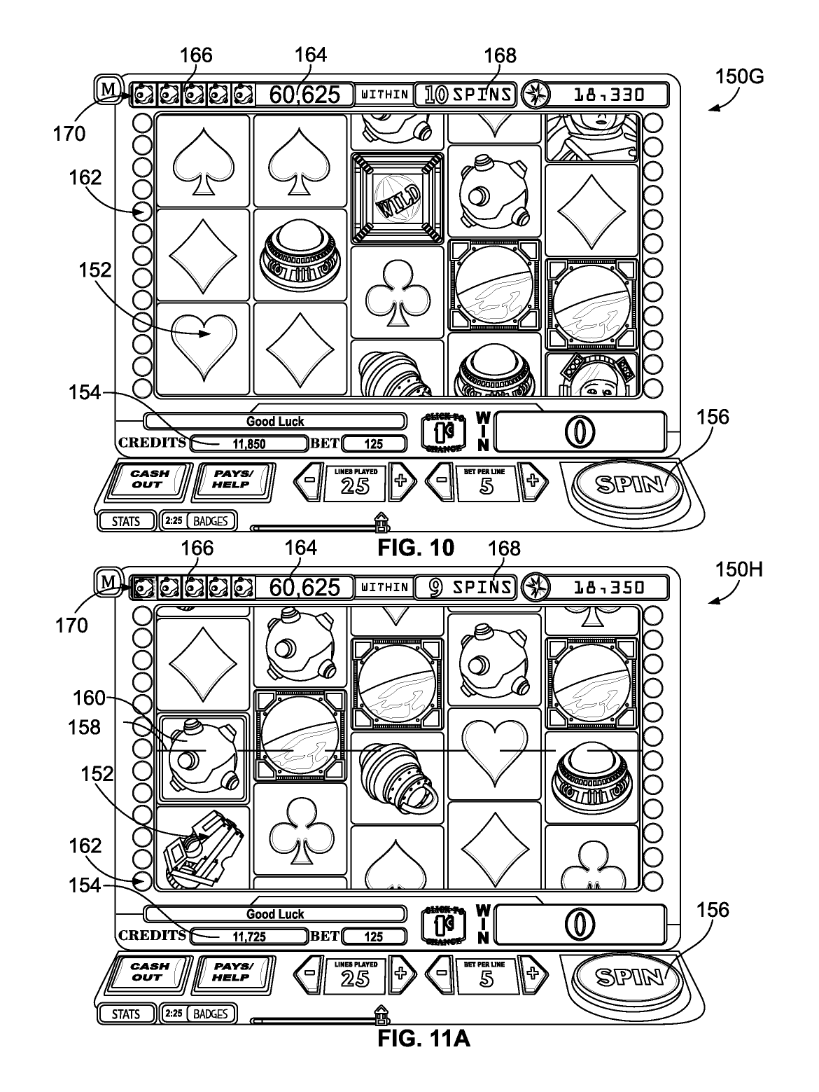

FIG. 10 illustrates a game screen 150G after the covering 172 has been removed to reset the variable award feature. As shown in FIG. 10, the variable award indicator 164 displays a new variable award of 60,625 credits, the win indicator 166 displays a new variable win condition that includes a five-symbol line pay outcome including five “sensor orb” symbols, and the play count indicator 168 displays the initial play-count value of ten plays.

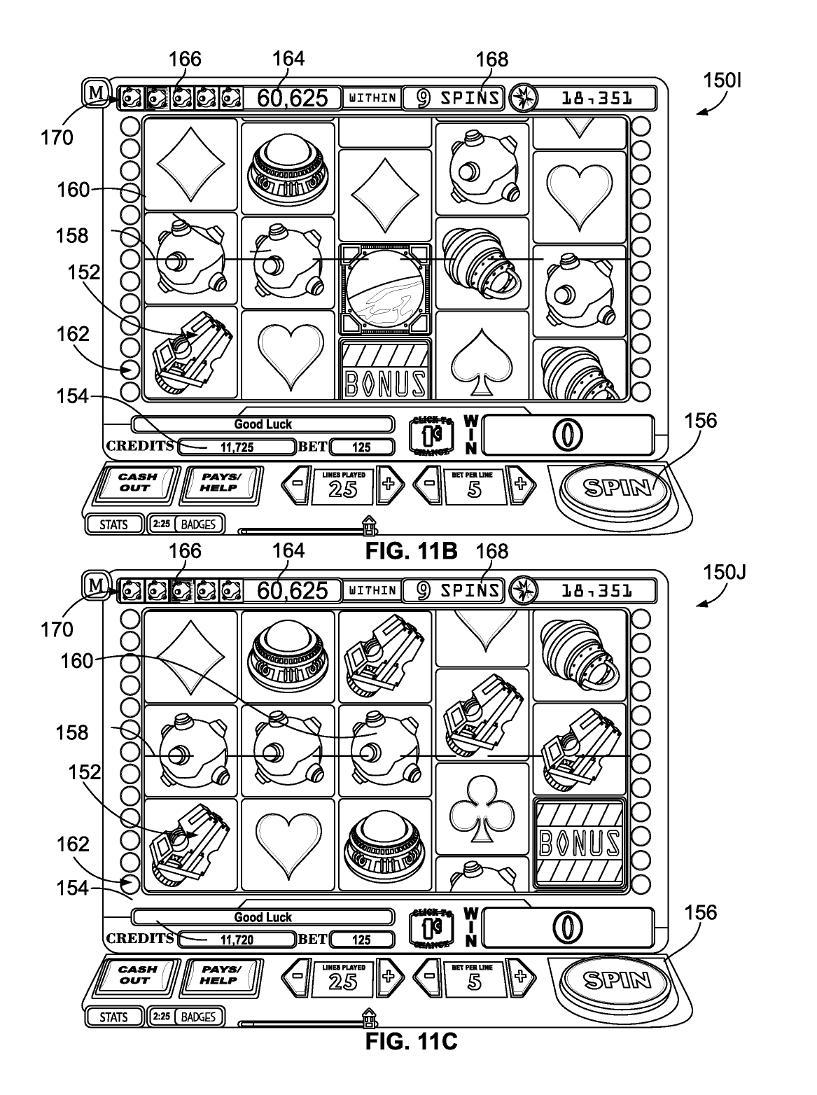

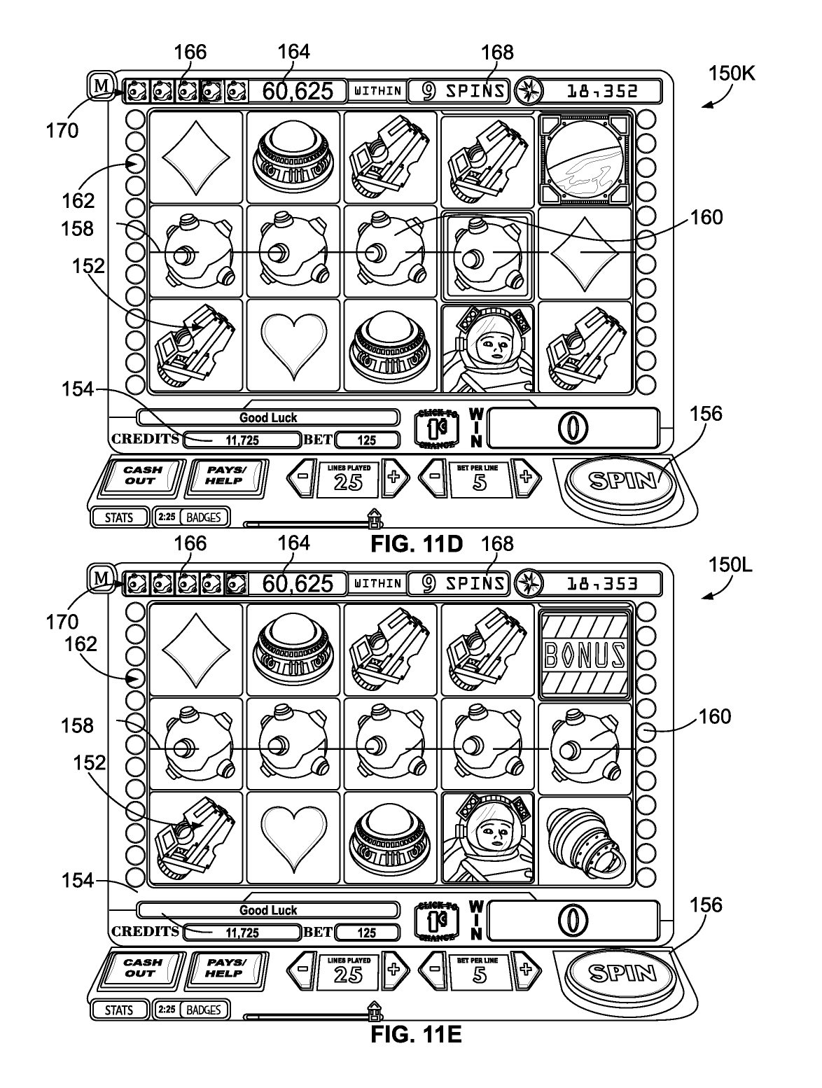

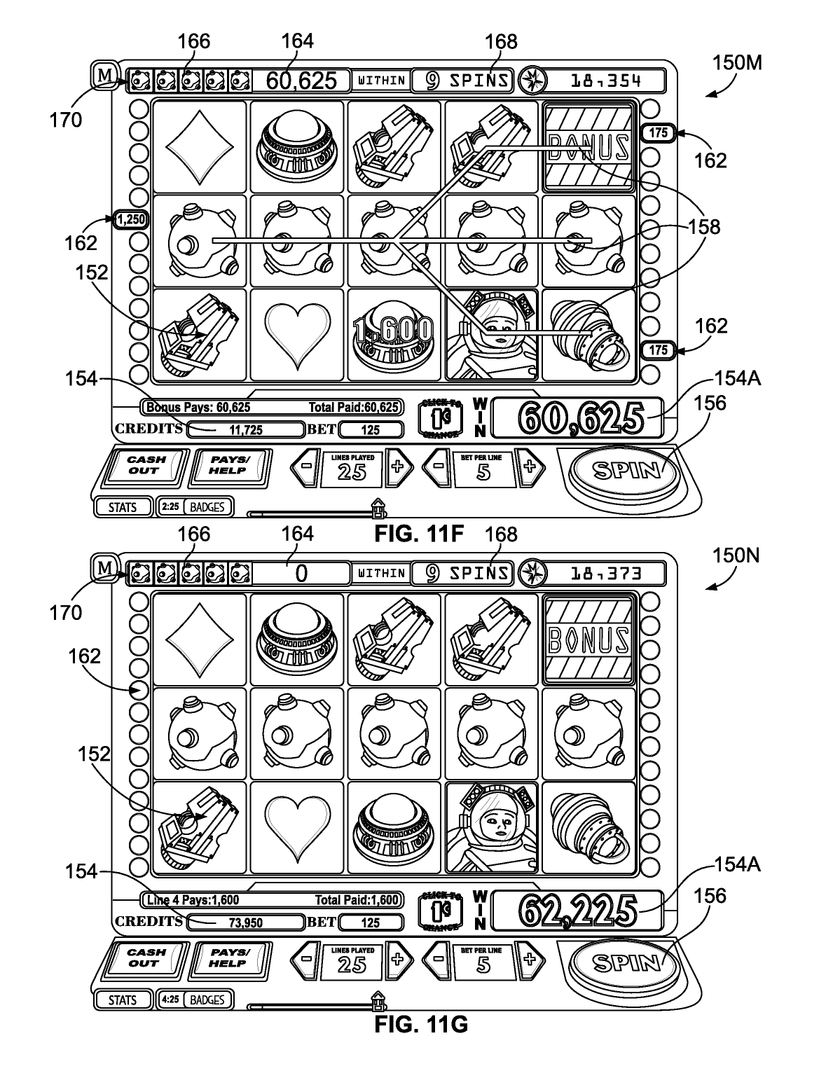

FIGS. 11A-11G illustrate game screens 150H-150N at various times during the first spin of the wagering game after the variable award feature transitions from the first iteration to the second iteration. FIG. 11A illustrates the game screen 150H after the player has initiated the play by setting the reels 152 in motion and, thus, the play count displayed in the play count indicator 168 has been decremented by one to indicate that at most nine plays remain until one of the reset conditions occurs. In particular, in FIG. 11A, the leftmost reel 152 has come to a stop while the remaining reels 152 continue to spin. Notably, a “sensor orb” symbol 160 matching the first symbol of the variable win condition has come to rest along at least one active payline 158. Thus, after the leftmost reel 152 has come to a stop, the partially displayed outcome for the play of the wagering game matches a corresponding part of the variable win condition displayed in the win condition indicator 166. The win condition indicator 166 can be configured to indicate the potential of the developing outcome for the play of the wagering game to achieve the variable win condition. In the illustrated example, the part of the variable win condition that matches the partially displayed outcome can be highlighted as each reel 152 comes to rest. Accordingly, in FIG. 11A, the leftmost symbol displayed in the win condition indicator 166 is highlighted.

FIG. 11B illustrates a game screen 150I after the next reel 152 has come to a rest while the three rightmost reels 152 continue to spin. As shown in FIG. 11B, a second “sensor orb” symbol 160 matching the variable win condition is positioned on at least one active payline 158. Accordingly, the win condition indicator 166 is highlighted in a corresponding manner to indicate the progress towards achieving the variable win condition. FIG. 11C and FIG. 11D illustrate similar game screens 150J, 150K as the third reel 152 (i.e., the center reel) and the fourth reel 152, respectively, come to rest. As shown in FIGS. 11C and 11D, the developing outcome includes additional “sensor orb” symbols 160 on at least one active payline 158 further matching the variable win condition and, thus, the win condition indicator 166 includes highlighting of the corresponding symbols comprising the variable win condition.

FIG. 11E illustrates a game screen 150L after the final, rightmost reel 152 has come to rest. As shown in FIG. 11E, the rightmost reel 152 also includes a “sensor orb” symbol 160 matching the last symbol of the variable win condition and the corresponding symbol of the variable win condition is highlighted in the win condition indicator 166. Thus, the outcome for the play of the wagering game illustrated in FIGS. 11A-11G includes the variable win condition.

In response to the outcome including the variable win condition, the player is awarded the variable award of 60,625 credits as shown in FIGS. 11F-11G. Additionally, as shown in FIG. 11F, the outcome includes three pay table based line pay outcomes for 1,250 credits, 175 credits, and 175 credits as indicated by the paylines 158 and the payline indicators 162. Accordingly, as shown in FIG. 11G, the player is awarded the variable award and the pay table award for a total of 62,225 credits as indicated in the win meter 154A. It is contemplated that the wagering game can be configured to provide celebratory graphics, animations, sounds, and lighting in response to the outcome including the variable win condition.

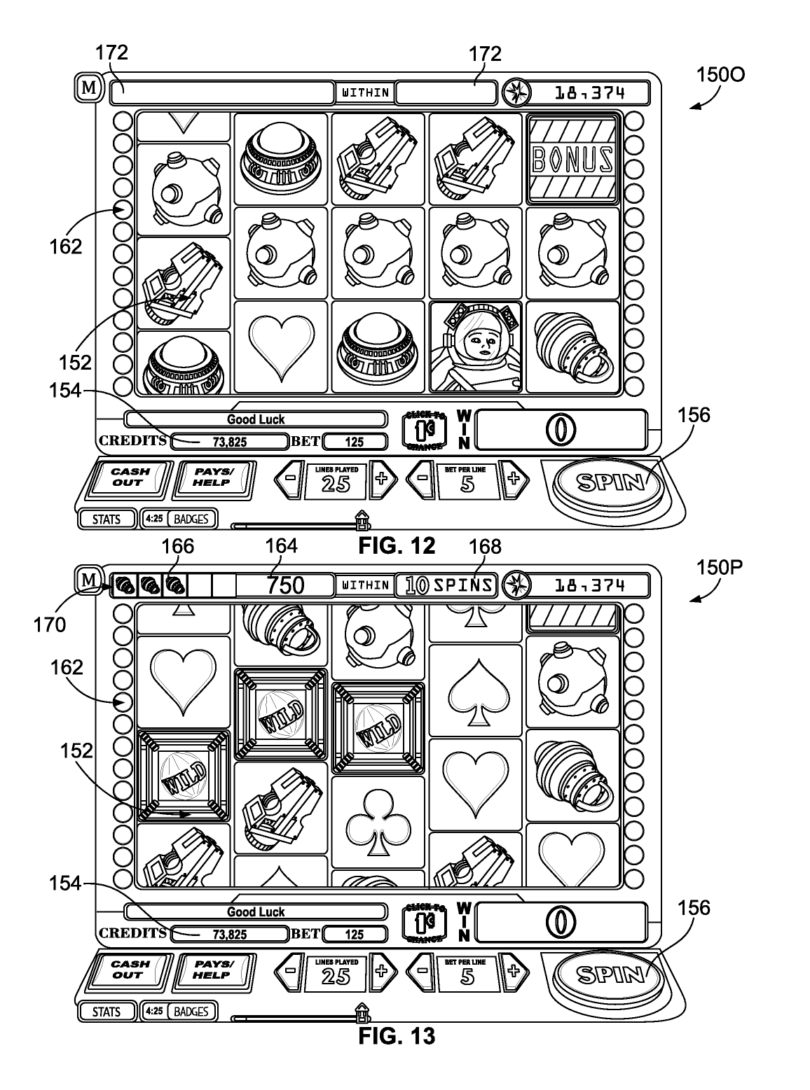

As described above, in the example illustrated in FIGS. 4-13, the reset condition includes the earlier occurrence of the play count running out or an outcome of the wagering game including the variable win condition. As the outcome shown in FIG. 11A-11G includes the variable win condition, the variable award feature is reset before the next play of the wagering game as shown in FIG. 12. In particular, FIG. 12 illustrates a game screen 1500 in which the covering 172 again extends over the banner 170 for a brief period of time to indicate the transition from the second iteration of the variable award feature to the next iteration. FIG. 13 shows a game screen 150P after the covering 172 has been removed from the banner 170 to reveal the variable award, the variable win condition, and the reset play count for the next iteration. As shown in FIG. 13, the variable award is 750 credits, the variable win condition is a three-symbol line pay outcome, and the play count is reset to ten plays.

As demonstrated by the example described and illustrated for FIGS. 4-13, the variable award feature enhances gameplay by providing the player with varying opportunities to receive different awards by achieving different win conditions before a play count runs out. Additionally, because the variable award is associated with the play count, the player is aware that knowing that he or she only has a limited number of attempts to achieve potentially valuable variable awards, which can provide a suspenseful and exciting gaming experience.

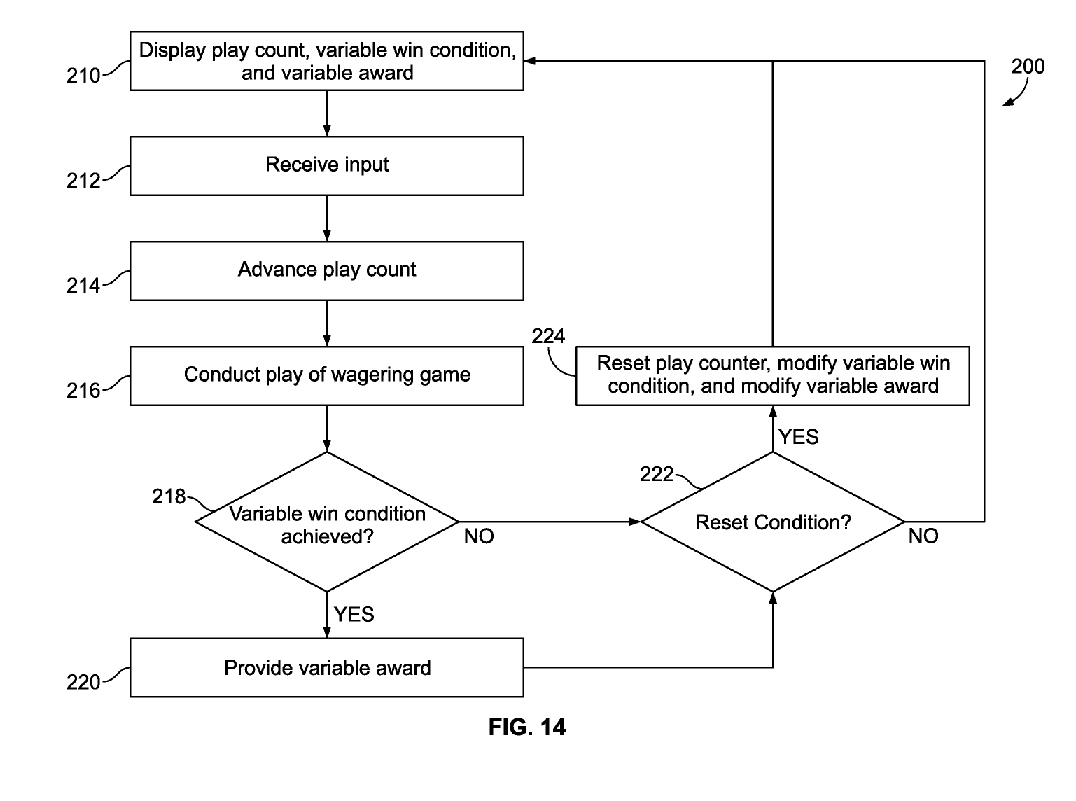

Referring now to FIG. 14, a flowchart of an exemplary process 200 for conducting a wagering game employing a variable ward feature is illustrated. At block 210, a play count, a variable win condition, and a variable award amount are displayed (e.g., on the primary display area 12 and/or the secondary display area 14). For example, the play count can be displayed in a play count indicator 168, the variable win condition can be displayed in a win condition indicator 166, and the variable award can be displayed in a variable award indicator 164. As described above, the play count indicator 168, the variable win indicator 166, and the variable award indicator 164 can be displayed in a banner 170.

At block 212, an input indicative of a wager to play the wagering game is received (e.g., via an input device 38). The play count can be advanced at block 214 in response to the receipt of the input at block 212. At block 216, the play of the wagering game is conducted. At block 218, it is determined whether the outcome of the play includes the displayed variable win condition. If it is determined at block 218 that the outcome of the play includes the variable win condition, the variable award is awarded to the player at block 220.

From block 220, the process 200 proceeds to block 222. Additionally, if it is determined that the outcome of the play does not include the variable win condition at block 216, the process 200 proceeds to block 222. At block 222, it is determined whether a reset condition occurred. According to some aspects, the reset condition includes the earlier occurrence of the play count running out (e.g., reaching a threshold number such as zero) or the outcome including the variable in condition. According to alternative aspects, the reset condition can include only the play count running out. If it is determined that a reset condition has not occurred at block 222, then the process returns to block 210 to repeat the process 200. On the other hand, if it is determined at block 222 that a reset condition has occurred, then the play counter is reset, the variable win condition is modified, and the variable award is modified at block 224. The process 200 then returns from block 224 to block 210 to repeat the process 200.

FIG. 14, described by way of example above, represents one algorithm that corresponds to at least some instructions executed by the CPU 30 in FIG. 2 to perform the above described functions associated with the described concepts. It is also within the scope and spirit of the present concepts to omit steps, include additional steps, and/or modify the order of steps presented above.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A computer-implemented method, comprising:
receiving, via an input device, an input indicative of a wager to play a wagering game;
displaying, on a display device, a play counter, a win condition, and an award for achieving the win condition in the wagering game, the play counter indicating a possible number of plays of the wagering game for which the award can be won by achieving the win condition;
for each play of the wagering game, using at least one of one or more processors to determine an outcome of the wagering game, advance the play counter in the absence of a reset condition, and provide the award if the win condition occurs in the wagering game; and
in response to the reset condition, using at least one of the one or more processors to reset the play counter, modify the win condition, and modify the award for achieving the modified win condition in the wagering game.

2. The method of claim 1, wherein the reset condition includes achieving the win condition.

3. The method of claim 1, wherein the reset condition includes the play counter reaching a threshold.

4. The method of claim 1, wherein the using the at least one of the one or more processors to reset the play counter includes resetting the play counter to a number of plays greater than one.

5. The method of claim 1, wherein the wagering game includes a plurality of symbol-bearing reels that, in each play, are rotated and stopped to populate a symbol array, and wherein the win condition includes one or more particular symbols or symbol combinations appearing in the symbol array.

6. The method of claim 1, wherein the award is selected from a group consisting of a monetary amount, an award multiplier, a bonus game, a modification to one or more symbols in the wagering game, and a game enhancement.

7. The method of claim 1, the displaying includes displaying the play counter, the win condition, and the award in a banner.

8. A gaming system comprising:
an input device;
a display device;
one or more memory devices storing instructions that, when executed by the one or more processors, cause the gaming system to:
receive, via the input device, an input indicative of a wager;
display, on the display device, a play counter, a win condition, and an award for achieving the win condition in the wagering game, the play counter indicating a possible number of plays of the wagering game for which the award can be won by achieving the win condition;
for each play of the wagering game, determine an outcome of the wagering game, advance the play counter in the absence of a reset condition, and provide the award if the win condition occurs in the wagering game; and
in response to the reset condition, reset the play counter, modify the win condition, and modify the award for achieving the modified win condition in the wagering game.

9. The gaming system of claim 8, wherein the reset condition includes achieving the win condition.

10. The gaming system of claim 8, wherein the reset condition includes the play counter reaching a threshold.

11. The gaming system of claim 8, wherein when the play counter is reset, the play counter is reset to a number of plays greater than one.

12. The gaming system of claim 8, wherein the wagering game includes a plurality of symbol-bearing reels that, in each play, are rotated and stopped to populate a symbol array, and wherein the win condition includes one or more particular symbols or symbol combinations appearing in the symbol array.

13. The gaming system of claim 8, wherein the award is selected from a group consisting of a monetary amount, an award multiplier, a bonus game, a modification to one or more symbols in the wagering game, and a game enhancement.

14. The gaming system of claim 8, wherein the play counter, the win condition, and the award are displayed in a banner.

15. One or more physical machine-readable storage media including instructions which, when executed by one or more processors, cause the one or more processors to perform operations comprising:
receiving, via an input device, an input indicative of a wager to play a wagering game;
displaying, on a display device, a play counter, a win condition, and an award for achieving the win condition in the wagering game, the play counter indicating a possible number of plays of the wagering game for which the award can be won by achieving the win condition;
for each play of the wagering game, determining an outcome of the wagering game, advancing the play counter in the absence of a reset condition, and providing the award if the win condition occurs in the wagering game; and
in response to the reset condition, resetting the play counter, modifying the win condition, and modifying the award for achieving the modified win condition in the wagering game.

16. The one or more physical machine-readable storage media of claim 15, wherein the reset condition includes achieving the win condition.

17. The one or more physical machine-readable storage media of claim 15, wherein the reset condition includes the play counter reaching a threshold.

18. The one or more physical machine-readable storage media of claim 15, wherein when the play counter is reset, the play counter is reset to a number of plays greater than one.

19. The one or more physical machine-readable storage media of claim 15, wherein the wagering game includes a plurality of symbol-bearing reels that, in each play, are rotated and stopped to populate a symbol array, and wherein the win condition includes one or more particular symbols or symbol combinations appearing in the symbol array.

20. The one or more physical machine-readable storage media of claim 15, wherein the award is selected from a group consisting of a monetary amount, an award multiplier, a bonus game, a modification to one or more symbols in the wagering game, and a game enhancement.
